(19) United States
(12) Patent Application Publication
(10) Pub. No.: US 2006/0075452 A1
(43) Pub. Date: Apr. 6, 2006

(54) Methods, systems, and computer program products for implementing interactive content-based activities

(76) Inventor: Robert Koch, Norcross, GA (US)

Correspondence Address: Philmore H. Colburn II;Cantor Colburn LLP, 55 Griffin Road South, Bloomfield, CT, 06002, US

(21) Appl. No.: 10/958,813

(22) Filed: Oct. 5, 2004

(51) Int. Cl. H04N 7/025; H04N 5/445; H04N 7/16; H04N 7/10; G06F 13/00

(52) U.S. Cl. 725/135; 725/42; 725/34

(57) ABSTRACT

Exemplary embodiments relate to methods, systems, and computer program products for implementing interactive content-based activities. The method includes selecting a content identifier in response to a broadcast. The content identifier is associated with the broadcast. The method also includes initiating a request for an activity via the content identifier. The content identifier is mapped to the activity.

### BACKGROUND OF THE INVENTION

Embodiments of the invention relate generally to communications systems, and more particularly, to methods, systems, and computer program products for implementing interactive content-based activities over a network.

Continuous advancements made with respect to technologies associated with the electronics industry have resulted in significant improvements in various product features of electronics devices such as personal and desktop computers, DVD players, and stereo systems, to name a few. For example, computer manufacturers now offer increased memory capacity, faster processors, longer battery life, etc. At the same time, electronics manufacturers are continuously striving to reduce the overall size of many of these devices, without sacrificing any of these improved features, in order to satisfy the demand for portability. As with standard or traditional electronics devices, portable electronics devices such as digital music players, personal digital assistants (PDAs) or ‘pocket PCs’, and the like are becoming increasing popular. Accordingly, electronics manufacturers and various service providers are constantly searching for new ways to provide value to the consumers of these devices in order to gain and maintain a competitive edge over their industry counterparts.

Another area that is experiencing growth in technology is the broadcast industry. The development of new standards in broadcast communications have enabled broadcast enterprises to deliver a variety of information, both related and unrelated to a broadcast, along with the actual broadcast content (e.g., music, audio/video programming, news, etc.). As long as the broadcast-receiving device is enabled with the standard, it can receive, translate, and respond to the delivered information. For example, a display on the receiving device (e.g., car stereo) may present information relating to content (such as a song) that is currently being broadcast such as a station identification of the broadcasting station, the artist name, and the title of the song, to name a few. Additionally, information unrelated to the content being broadcast (such as advertising) may be delivered and presented. While having this additional information may be useful, the technology does not currently support interactive communications between a broadcast recipient and the sources related to the content broadcast. For example, in response to hearing a song broadcast on a recipient's receiving device, the recipient may desire to contact a source to purchase the song (e.g., via download or placing an order with a music provider) at the time of the broadcast or shortly thereafter.

It is desirable, therefore, to provide a means for enabling interactive communications between a recipient of a broadcast and a content provider or a source related to the broadcast content.

### SUMMARY OF THE INVENTION

Exemplary embodiments of the invention relate to methods, systems, and computer program products for implementing interactive content-based activities over a communications network. Methods include selecting a content identifier in response to a broadcast. The content identifier is associated with the broadcast. The methods also include initiating a request for an activity via the content identifier. The content identifier is mapped to the activity.

Exemplary embodiments further include an apparatus for implementing interactive content-based activities. The apparatus includes a content receiver for receiving a broadcast and a content identifier. The content identifier is associated with the broadcast. The apparatus also includes a content storage/player in communication with the content receiver for selecting the content identifier from the content receiver and initiating a request for an activity via the content identifier. The content identifier is mapped to the activity.

Exemplary embodiments also include methods for implementing interactive content-based activities. Methods include associating a content identifier with a broadcast event; mapping the content identifier to an activity, the activity including at least one of a product purchase, a service purchase, an information request, a contest entry, and a promotional event or other event; and storing the results of the mapping in a table. Methods also include receiving a request to initiate the activity, the request including a corresponding content identifier; retrieving information relating to the activity from the table; and executing the request.

Exemplary embodiments further include systems for implementing interactive content-based activities over a communications network. Systems include a transaction server for associating a content identifier with a broadcast event and mapping the content identifier to an activity, the activity including at least one of a product purchase, a service purchase, an information request, a contest entry, and a promotional event or other event. Systems further include a storage device in communication with the transaction server, the storage device operable for storing results of the mapping in a table; and a network link to a content storage/player, the content storage/player in communication with a receiver. Upon receiving a request to initiate the activity from the content storage/player, the transaction server retrieves information relating to the activity from the table and executes the request, the request including a corresponding content identifier.

Exemplary embodiments also include computer program products encoded with program code for implementing interactive content-based activities. The program code includes instructions for causing a processor to select a content identifier in response to a broadcast. The content identifier is associated with the broadcast. The processor further initiates a request for an activity via the content identifier. The content identifier is mapped to the activity.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which interactive content-based activities may be implemented in exemplary embodiments;

FIG. 2 is a block diagram of a content receiver and its components in exemplary embodiments;

FIG. 3 is a block diagram of a content storage/player and its components in exemplary embodiments; and

FIG. 4 is a flow diagram of a process for implementing the interactive content-based activities in exemplary embodiments.

### DETAILED DESCRIPTION OF THE INVENTION

In accordance with exemplary embodiments, the interactive content-based activities system provides a means by which a recipient of broadcast content (also referred to herein as “broadcast”) may initiate a real-time request for an item, service, or information (collectively referred to herein as “activity”) that is associated with the broadcast content. Broadcast content may include music, audio/video programming, advertising, news, etc., that is transmitted via, e.g., over-the-air radio frequency (RF) signals, satellite technology, or digitally over a network, to name a few. A unique content identifier is assigned to each broadcast event and is transmitted together with the broadcast event. Using the content identifier, a recipient of the broadcast content may initiate a request for an activity that is related to the broadcast content. The request may be initiated during the broadcast or sometime after the broadcast has completed.

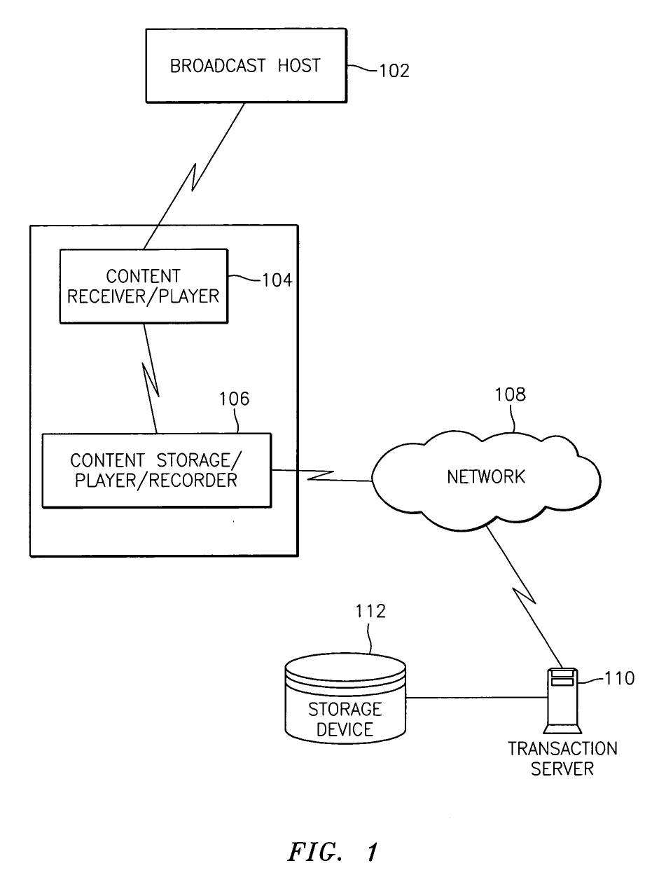

Referring now to FIG. 1, a block diagram of an exemplary system for implementing interactive content-based activities is generally shown. The exemplary system of FIG. 1 includes a broadcast host system 102 in communication with a content receiver 104. Broadcast host system 102 provides broadcast content (e.g., music, programming, sports, news, advertising, etc.) to content receiver 104 via a transmissions means such as over-the-air radio frequency (RF) signals or a digital network (e.g., broadband digital subscriber line (DSL)). In addition to transmitting content, broadcast host system 102 also transmits supplementary content information in the form of digital encoded signals. The supplementary content information may include for example, the identification of the broadcast host system, the artist/composer/owner of the content, the title of the content, a content identifier that distinguishes the content from other broadcast items, etc. Broadcast host system 102 may be a radio station or Internet radio service provider that transmits audio content, a television or other audio/video content service provider, or other similar type of content provider system. Additionally, the content that is broadcast may comprise any type of media (e.g., video, images, text, etc.).

In accordance with one embodiment, broadcast host system 102 is a broadcast radio station that transmits content via radio frequency (RF) signals. Broadcast host system 102 provides Radio Data System (RDS), Radio Broadcast Data System (RBDS), or similar type of service to its customers. For example, in addition to transmitting traditional content (e.g., music, programming, advertisements), radio stations may transmit supplementary information in the form of encoded digital signals that are received and analyzed by an RDS/RBDS-enabled receiver. RDS/RBDS technology enables a receiver to identify the radio station it is tuned into, offers the ability to pre-select programming types from available stations (e.g., music only content), a broadcast intercept feature that provides traffic advisory information, as well as other capabilities. The RDS and RBDS specifications have been adopted by official standardization bodies such as the European Center for Electrotechnical Standardization (CENELEC) in Europe, as well as the National Radio System Committee (NRSC) of the National Association of Broadcasters® (NAB) and the Electronic Industries Association (EIA) in the United States.

In exemplary embodiments, content receiver 104 receives broadcast signals (e.g., RF, data, satellite) from broadcast host system 102, translates the signals, and presents the resulting content to a broadcast recipient. Content receiver 104 may also receive audio content from other broadcast host systems (e.g., multiple radio stations) within its range. In one embodiment, content receiver 104 is a radio that is built in to an RDS/RBDS-enabled automobile that receives RF signals (e.g., FM) from broadcast host system 102 via a receiver located on the automobile. Alternatively, the automobile described above with respect to the content receiver 104 may employ a global positioning system (GPS) device whereby broadcast content is transmitted to the content receiver 104 via satellite. In other embodiments, content receiver is an RDS/RBDS-enabled home stereo system that receives RF signals from broadcast host system 102. Content receiver 104 converts the signals to audio signals and presents the resulting audio content to a listener as well as the supplementary data facilitated by the RDS/RBDS services. In yet further embodiments, content receiver 104 may be a television or personal computer that receives broadcast content via a network, e.g., digital subscriber line (DSL) or cable services.

In exemplary embodiments, content storage/player 106 includes an intelligent device that stores and plays recorded or downloaded content. Content storage/player 106 may communicate with content receiver 104 via a Universal Serial Bus (USB) cable or via wireless technologies, e.g., Bluetooth™ or short messaging service (SMS). Content storage/player 106 may also include input/output controls or options as well as a user interface for implementing the interactive content-based activities as will be described further herein. It will be understood that the form of user interface may vary from one type of content device to another (e.g., voice prompts and selections via key depressions may be used on a cellular telephone, web page user interface screen for a computer user, etc.); however, in exemplary embodiments the functionality of the user interface remains the same across all content storage/player devices.

Content storage/player 106 may be a portable device that includes digital recording and playback features such as those provided by, e.g., an iPod® player by Apple Computer, Inc® of Cupertino, Calif., or an iAUDIO M3® by Cowon Systems, Inc. of Seoul, Korea. In alternate embodiments, content storage/player 106 may be a web-enabled cellular telephone, personal digital assistant (PDA), a computer, an Internet-enabled television, etc.

Content storage/player 106 may store a variety of content such as digital games, pictures, and personal data (e.g., calendars, organizers, etc.). Content storage/player 106 may play recorded music in an audio format such as Moving Picture Experts Group Audio Level 3 (MP3), Advanced Streaming Format (ASF), or WAV.

In yet further embodiments, content receiver 104 and content storage/player 106 comprise a single unit. For example, together content receiver 104 and content storage/player 106 may comprise a personal computer. The personal computer receives broadcast content, e.g., Internet radio over a packet-switched network. The personal computer may include software for identifying participating Internet radio stations and receive broadcast content in the form of distributed streaming audio. The computer may comprise a desktop, laptop, or other similar general-purpose computing device known in the art. The computer may include memory (e.g., removable storage media, hard disk drive) for storing information such as files, documents, images, audio, applications, and multimedia.

Also included in the exemplary system of FIG. 1 is a transaction server 110 and storage device 112. Transaction server 110 may communicate with content storage/player 106 via a network 108. Content storage/player 106 (or both of content receiver 104 and content storage/player 106 if they comprise a single unit) may communicate with transaction server 110 utilizing one or a combination of communications technologies including, e.g., satellite or cellular technology, wireless technologies, circuit-switched networking, and packet-switched networking, among others. In exemplary embodiments of the present invention, transaction server 110 operates as a database server and coordinates access to applications and data stored on the storage device 112.

The transaction server 110 depicted in the system of FIG. 1 may be implemented using one or more servers operating in response to a computer program stored in a storage medium accessible by the server 110. The transaction server 110 may operate as a network server (e.g., a web server) to communicate with requesting devices such as content storage/player 106. The transaction server 110 handles sending and receiving information to and from the content storage/player 106 and can perform associated tasks. The transaction server 110 may also include a firewall to prevent unauthorized access to the server and enforce any limitations on authorized access. For instance, an administrator may have access to the entire system and have authority to modify portions of the system. A firewall may be implemented using conventional hardware and/or software as is known in the art.

The transaction server 110 may also operate as an application server. The transaction server 110 executes one or more computer programs (i.e., an application for implementing the interactive content-based activities) to provide the functions described herein. Processing may be shared by the content storage/player 106 and the transaction server 110 by providing an application (e.g., java applet) to the content storage/player 106. Alternatively, the content storage/player 106 may include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

The storage device 112 includes data relating to broadcast content, supplementary information such as broadcast sources and content identifiers, as well as associated activities and may be implemented using a variety of devices for storing electronic information. It is understood that the storage device 112 may be implemented using memory contained in the transaction server 110 or it may be a separate physical device. The storage device 112 is logically addressable as a consolidated data source across a distributed environment that includes network 108. Information stored in the storage device 112 may be retrieved and manipulated via the transaction server 110. In exemplary embodiments, storage device 112 stores tables of content identifiers and associated information for implementing the interactive content-based activities. Content identifiers are associated with specific broadcast content and are also mapped to specific activities. The activities are implemented in response to requests received via the corresponding content identifiers. The following table illustrates a sample table.

| Content_ID | BROADCAST | ACTIVITY |
|---|---|---|
| MU1000893 | Song | Download Song file |
| MU1006199 | Advertisement | Purchase concert tix |
| MU6974448 | Station promotion | Enter Contest |

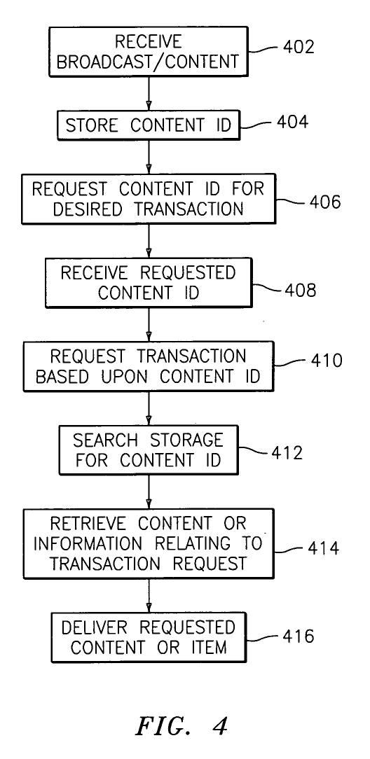

Referring to the above table, a broadcast recipient hears a song that is received along with a corresponding content identifier “MU1000893”. The recipient transmits a request to server 110 that includes the content identifier. The transaction server 110 maps the content identifier to the activity “Download Song file”. The transaction server 110 then implements the request by enabling the recipient to download the song heard in the broadcast to the content storage/player 106. Details of this process are described further in FIG. 4.

As indicated above, the system of FIG. 1 also includes a network 108. The network 108 may be any type of known network including, but not limited to, a wide area network (WAN), a local area network (LAN), a global network (e.g. Internet), a virtual private network (VPN), and an intranet. The network 108 may be implemented using a wireless network or any kind of physical network implementation known in the art.

It will be understood that other types of content storage/players (e.g., digital cameras, personal video recorders, etc.) may also be utilized in implementing the interactive content-based activities. Accordingly, the content devices described above with respect to the system of FIG. 1 are provided for illustrative purposes and are not to be construed as limiting in scope.

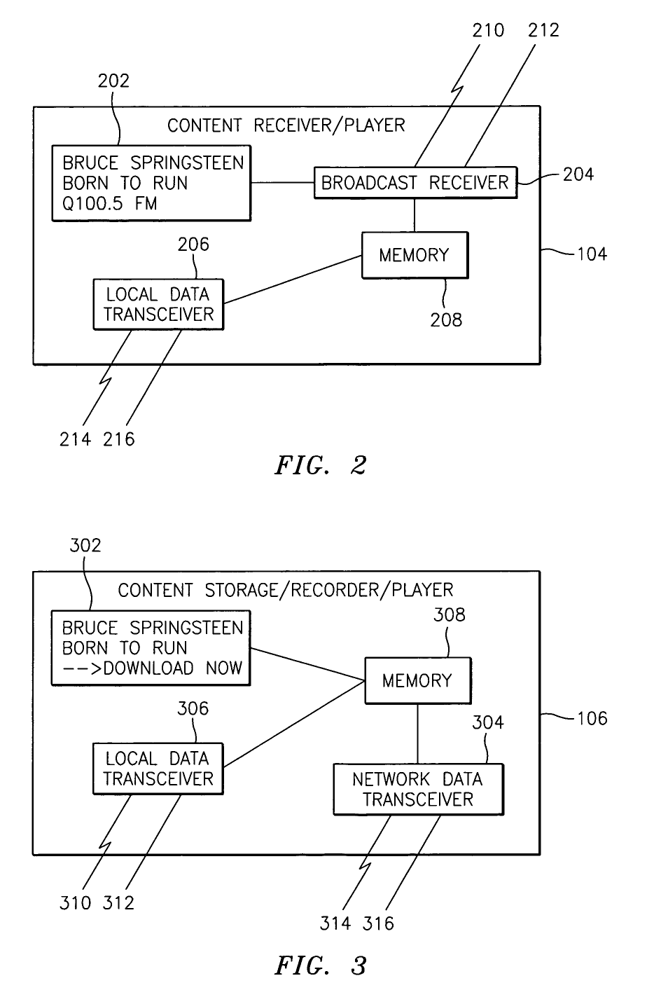

Turning now to the block diagram of FIG. 2, an exemplary content receiver and its components will now be described. Content receiver 104 includes a display means 202 for presenting information (including supplementary information) relating to a broadcast to a recipient. A broadcast receiver 204 receives and translates broadcast signals, including the supplementary data, that are transmitted using over-the-air RF signaling means 210 or may be data signals (e.g., data packets) that are transmitted using, e.g., a packet-switched network 212. Broadcast receiver 204 then sends the translated supplemental data to the display means 202. As shown in the diagram of FIG. 2, supplementary information presented in display means 202 includes an artist name, song title, and station identification. Optionally, the content identifier of the current broadcast event may be displayed.

The content identifier of a current broadcast, as well as other supplementary information, may be stored in memory 204 residing within content receiver 104. Alternatively, a log of recently broadcast content identifiers may be stored in memory 208. Content receiver 104 also includes a local data transceiver 206 that communicates with content storage/player 106 via wireless means (e.g., short messaging service, Bluetooth™, etc.) 214 or may communicate with content storage/player 106 via wireline means (e.g., USB cable) 216.

An exemplary diagram of a content storage/player will now be described with respect to FIG. 3. Content storage/player 106 includes a display means 302, a memory 308, a local data transceiver 306, and a network data transceiver 304. As described above, content storage/player 106 may communicate with content receiver 104 via wireless means (e.g., short messaging service, Bluetooth™, etc.) 214 or may communicate with content receiver 104 via wireline means (e.g., USB cable) 216. This communication is facilitated by the local data transceiver 306 of content storage/player 106.

Memory 308 may store content in accordance with the type of content storage/player 106 being utilized (e.g., a digital music player storing audio content, a personal computer storing video, etc.). Memory 308 may also store an executable application for implementing the interactive content-based activities described herein. Memory 308 may communicate with display 302 when a recipient initiates a request via input controls on content storage/player 106. Network data transceiver 304 communicates with transaction server 110 over a wireless network 314 or wireline network 316 similar to those described above.

An exemplary process for implementing the interactive content-based activities will now be described with respect to FIG. 4. For purposes of illustration, the processes described with respect to FIG. 4 refer to broadcast content consisting of music and the requested activity refers to a request to download a song file. However, it will be understood by those skilled in the art that any type of broadcast content and/or activity may be applied to the processes described herein.

At step 402, a broadcast is received by content receiver 104 from broadcast host system 102. In addition to the subject content (e.g., song), the broadcast content also includes supplementary information (e.g., the identification of the broadcast host system, the artist/composer/owner of the content, the title of the content, a content identifier that distinguishes the content from other broadcast items, etc.) via RDS/RBDS or other technologies. Content receiver 104 stores the content identifier at step 404 and may also store a log of recent broadcasts which includes one or more of the above associated supplemental information items. The content identifiers are each mapped to the broadcast and an activity and are stored in one or more tables in storage device 112.

When an individual is interested in an activity associated with a broadcast, the individual selects an option on the content storage/player 106 in order to obtain the corresponding content identifier at step 406. Upon selecting the option, the content storage/player 106 initiates a communication session with the content receiver 104 via communications means 214 or 216, requesting the current content identifier (if the broadcast is currently underway) or may optionally request the log from the memory 208 in content receiver 104. At step 408, the individual selects the desired content identifier from the log that is shown in the display 302 of content storage/player 106.

An option exists for the individual to then initiate a request associated with the content identifier. For example, a request option 310 “Download Now” is shown on display 302 for selection by a recipient. Upon selecting this option, the content storage/player 106 initiates a session over network 108 via communications means 314 or 316 and contacts transaction server 110 at step 410. Transaction server 110 performs a search of storage device 112 using the content identifier as a key at step 412. The activity or item mapped to the content identifier is retrieved at step 414. Transaction server 110 responds to the request in accordance with the requirements defined for the activity. By way of the example above, the recipient downloads the requested song.

As described above, the interactive content-based activities system provides a means by which a recipient of broadcast content may initiate a real-time request for an item, service, or information that is associated with the broadcast content. Broadcast content may include a variety of media types that are transmitted over a network. A unique content identifier that is assigned to each broadcast event is transmitted along with the broadcast event and is used by a recipient to initiate a request for an activity related to the broadcast content. The request may be initiated during the broadcast or for a defined period of time after the broadcast has completed.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for implementing interactive content-based activities, comprising:
selecting a content identifier in response to a broadcast, the content identifier associated with the broadcast; and
initiating a request for an activity via the content identifier, the content identifier being mapped to the activity.

2. The method of claim 1, wherein the content identifier is received simultaneous with the broadcast.

3. The method of claim 1, further comprising requesting a log of content identifiers associated with current or recent broadcasts, wherein the selecting includes selecting a content identifier from the log.

4. The method of claim 1, wherein the broadcast includes at least one of:
a video program;
an audio program;
music;
news;
sports;
advertisement;
promotion;
movie;
radio frequency broadcast; and
Internet radio broadcast.

5. The method of claim 1, wherein the content identifier is transmitted using Radio Data System or Radio Broadcast Data System standards.

6. The method of claim 1, wherein the request is initiated during the broadcast that is associated with the selected content identifier.

7. The method of claim 1, wherein the activity includes at least one of:
a content download including at least one of:
software;
document;
music file;
video file;
image; and
a multi-media item;
information relating to the broadcast;
a document;
additional data related to the broadcast;
a contest entry;
a product purchase; and
a service purchase.

8. The method of claim 1, wherein the content identifier is selected via at least one of a:
personal computer;
personal digital assistant;
a web-enabled cellular telephone; and
a web-enabled digital media device.

9. The method of claim 1, wherein the request is initiated via at least one of a:
personal computer;
personal digital assistant;
a web-enabled cellular telephone; and
a web-enabled digital media device.

10. An apparatus for implementing interactive content-based activities, comprising:
a content receiver for receiving a broadcast and a content identifier, the content identifier associated with the broadcast; and
a content storage/player in communication with the content receiver, the content storage/player operable for selecting the content identifier from the content receiver and initiating a request for an activity via the content identifier, the content identifier being mapped to the activity.

11. The apparatus of claim 10, wherein the content identifier is received simultaneous with the broadcast.

12. The apparatus of claim 10, wherein the content storage/player includes:
a local data transceiver for receiving supplementary content information from a receiving device, the receiving device providing a broadcast event;
a display means in communication with the local data transceiver, the display means operable for displaying the supplementary content information and selectable options;
an input means for requesting the supplementary content information and selecting one of the available options; and
a network data transceiver for initiating a request for an activity associated with the broadcast event, the activity mapped to the supplementary content information.

13. The apparatus of claim 10, wherein the broadcast includes at least one of:
a video program;
an audio program;
music;
news;
sports;
advertisement;
promotion;
movie;
radio frequency broadcast; and
Internet radio broadcast.

14. The apparatus of claim 10, wherein the request is initiated during the broadcast that is associated with the selected content identifier.

15. The apparatus of claim 10, wherein the activity includes at least one of:
a content download including at least one of:
software;
document;
music file;
video file;
image; and
a multi-media item;
information relating to the broadcast;
a document;
a contest entry;
a product purchase; and
a service purchase.

16. A method for implementing interactive content-based activities, comprising:
associating a content identifier with a broadcast event;
mapping the content identifier to an activity, the activity including at least one of a product purchase, a service purchase, an information request, a contest entry, and a promotional event;
storing results of the mapping in a table;
receiving a request to initiate the activity, the request including a corresponding content identifier;
retrieving information relating to the activity from the table; and
executing the request.

17. The method of claim 16, wherein the broadcast event includes at least one of:
a video program;
an audio program;
music;
news;
sports;
advertisement;
promotion;
movie;
radio frequency broadcast; and
Internet radio broadcast.

18. A system for implementing interactive content-based activities, comprising:
a transaction server for associating a content identifier with a broadcast event and mapping the content identifier to an activity, the activity including at least one of a product purchase, a service purchase, an information request, a contest entry, and a promotional event;
a storage device in communication with the transaction server, the storage device operable for storing results of the mapping in a table; and
a network link to a content storage/player, the content storage/player in communication with a receiver;
wherein upon receiving a request to initiate the activity from the content storage/player, the transaction server retrieves information relating to the activity from the table and executes the request, the request including a corresponding content identifier.

19. The system of claim 18, wherein the broadcast event includes at least one of:
a video program;
an audio program;
music;
news;
sports;
advertisement;
promotion;
movie;
radio frequency broadcast; and
Internet radio broadcast.

20. The system of claim 18, wherein the request is initiated during the broadcast event that is associated with the selected content identifier.

21. The system of claim 18, wherein the activity includes at least one of:
a content download including at least one of:
software;
document;
music file;
video file;
image; and
a multi-media item;
information relating to the broadcast;
a document;
a contest entry;
a product purchase; and
a service purchase.

22. A computer program product for establishing a trusted network, the computer program product comprising:
a storage medium readable by a processing circuit and storing instructions for execution by the processing circuit for facilitating a method comprising:
selecting a content identifier in response to a broadcast, the content identifier associated with the broadcast; and
initiating a request for an activity via the content identifier, the content identifier being mapped to the activity.

23. The computer program product of claim 22, wherein the content identifier is received simultaneous with the broadcast.
